(19) United States
(12) Patent Application Publication
(10) Pub. No.: US 2026/0346677 A1
(43) Pub. Date: Nov. 5, 2026

(54) Air Splitter for an Air Conditioner and Corresponding Air Conditioner

(71) Applicant: Truma Gerätetechnik GmbH & Co. KG, Putzbrunn (DE)

(72) Inventor: Andreas Beyer, Putzbrunn (DE)

(21) Appl. No.: 19/112,149

(22) PCT Filed: Oct. 5, 2023
(86) PCT No.: PCT/EP2023/077551

§ 371 Date: Mar. 14, 2025

(30) Foreign Application Priority Data
Oct. 17, 2022 (DE) 102022003841.2

(51) Int. Cl. B60H 1/00

(52) U.S. Cl. CPC B60H 1/00364; B60H 2001/00185; B60H 2001/00235

(57) ABSTRACT

The invention relates to an air splitter (2) for an air conditioner, the air splitter (2) having a separating wall (20) and a distribution base (21), which form the shape of the letter L.

### TECHNICAL FIELD

The present invention relates to an air splitter for an air conditioner for conditioning, in particular for cooling, the air in a space. Furthermore, the invention relates to an air conditioner with an air splitter. The air conditioner is designed especially for installation on a roof, e.g. on the roof of a vehicle (e.g. a mobile home or a caravan).

### BACKGROUND

The principle of cold generation underlying air cooling by means of a cooling circuit is described, for example, in WO 2007/042065 A1. In so-called roof-mounted air conditioning systems, which are used in caravans or mobile homes, for example, the components of the cooling circuit (i.e. fan, heat exchanger, evaporator, condenser) are installed in a housing on the roof of the vehicle. There is only an interior air distributor present inside the vehicle. A recess is provided in the roof so that air from the interior can be discharged as air to be conditioned and then reintroduced into the interior as conditioned air. It is possible that the components of the cooling circuit and the interior air distributor are located directly above or below the recess. This essentially creates a through-going air path. Alternatively, the cooling circuit and the interior air distributor are coupled together via a duct system in the ceiling. If air to be conditioned is taken out of the interior and conditioned air is introduced into the interior through an opening in the roof, it must be avoided that the two air flows mix together or that a thermally conductive connection occurs. One approach would be to use two openings and connect each one separately to the components of the cooling circuit. However, this makes installation more complex and reduces the overall aesthetic impression of the interior.

### SUMMARY

The object of the invention is to make it possible to guide two different air flows through an opening in a ceiling.

The invention solves the problem by an air splitter for an air conditioner, wherein the air splitter has a separating wall and a distribution base, and wherein the separating wall and the distribution base are designed and arranged relative to one another such that they form the shape of the letter L.

The air splitter according to the invention consists of two functional components. This is, on the one hand, a separating wall and, on the other hand, a distribution base, both of which together form the capital letter L. The angle between the two can deviate from a right angle by up to plus/minus 10 degrees. The transition between both components can also be rounded. The lower part of the letter L is preferably formed by the distribution base, which distributes the conditioned air laterally when installed. The separating wall separates the space behind it from the space in which the distribution base is located and which thus partially delimits the distribution base downwards. If the air splitter is arranged relative to an opening in the roof, the separating wall separates a space for the air to be conditioned from a space for the conditioned air. The conditioned air is also distributed in one plane by the distribution base and can therefore, for example, direct the air into different ducts when installed.

One design of the air splitter consists in that the separating wall has a stair structure. The stair structure allows the thickness of the separating wall to decrease from the bottom—i.e. from the area of the distribution base—upwards. The stairs should preferably be the same height, e.g. ½ inch. The tops of the stairs preferably run essentially parallel to the base of the separating wall. Such stairs are useful, for example, when the installation of the air splitter requires the adaptation to different ceiling thicknesses. This means that the height of the separating wall can be adjusted depending on the thickness of the ceiling or the depth of the recess in the ceiling, for example by cutting off a part of the separating wall that is too high. This means that simple and reliable adaptation to the specific application is possible.

The above-mentioned embodiment is in particular an embodiment of the variant in which the thickness of the separating wall is not constant, but decreases from bottom to top.

One embodiment of the air splitter provides that the air splitter is designed in one piece.

One embodiment of the air splitter provides that at least the separating wall is made of a foamed plastic—preferably expanded polypropylene, EPP.

One embodiment of the air splitter provides that the distribution base has a wedge-shaped elevation. When the air hits this wedge, it is directed to the side and thus distributed in two directions.

One embodiment of the air splitter provides that the air splitter has a thermal insulator. The thermal insulator is provided, for example, by an aluminum strip. The insulation prevents a thermal short circuit between the two different air flows.

Furthermore, the invention achieves the object by means of an air conditioner for installation on a roof, wherein the air conditioner has an air splitter according to any one of the embodiments described above or in the following.

The embodiments of the air splitter and the associated designs also refer correspondingly to the air conditioner with the air splitter. Therefore, a repetition is omitted.

One embodiment of the air conditioner provides that the air conditioner has a housing, that in a mounted state the housing rests on the roof, and that in the mounted state the air splitter is at least partially arranged in a recess of the roof.

An embodiment of the air conditioner includes that the air conditioner has components for generating a refrigeration circuit, that the components are at least a compressor, a condenser, an expansion device and an evaporator, and that at least one component is arranged in the housing. In a further embodiment, the four aforementioned components are arranged in the housing and thus outside the space to be conditioned.

### BRIEF DESCRIPTION OF THE DRAWINGS

In particular, there are several possibilities for designing and further developing the air splitter and the air conditioner according to the invention. Reference is hereby made to the following description of exemplary embodiments in conjunction with the drawing. In the drawings:

FIG. 1 shows a schematic representation of an air conditioner installed on a roof,

FIG. 2 shows a spatial representation of an air splitter,

FIG. 3 shows a plan view of the air splitter of FIG. 2 and

FIG. 4 shows a section through the air splitter of FIG. 2 in the mounted state.

### DETAILED DESCRIPTION

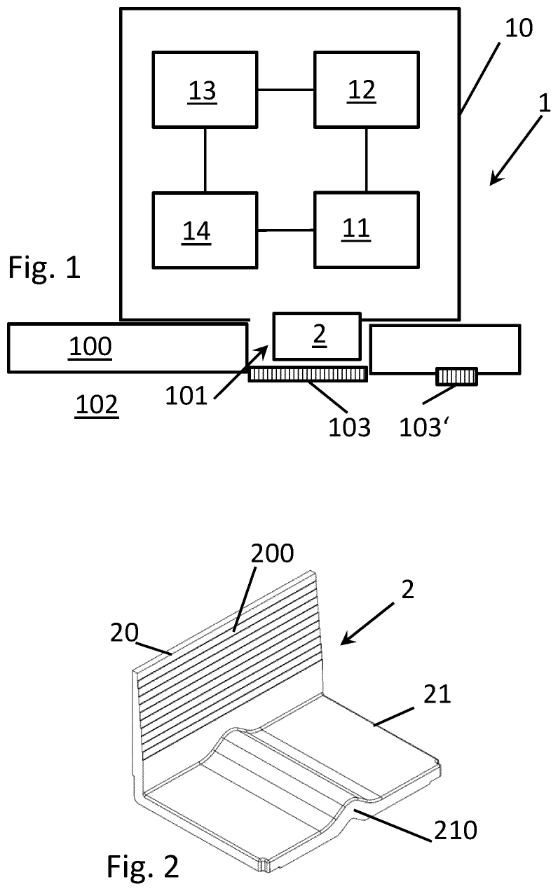

FIG. 1 schematically shows the structure of an air conditioner 1 for cooling a space 102 which is located below a roof 100. The roof 100 belongs, for example, to a caravan or a motor-home or a boat.

In the embodied cooling circuit, a compressor 11 compresses a gaseous refrigerant, which heats up and is transported via a refrigerant line to a condenser 12. In the condenser 12, the heat of the refrigerant is transferred—via a heat exchanger not shown here—to the ambient air (or outside air) from the environment around the space 102. The liquid refrigerant, which is still under high pressure, is expanded to a lower pressure in an expansion device 13, which is designed, for example, as a throttle, whereby it cools down. In the evaporator 14, the air is cooled via another heat exchanger by transferring its thermal energy to the refrigerant. As a result, the refrigerant changes into a gaseous state. The gaseous refrigerant finally returns to the compressor 11 so that the cooling cycle can be continued. The components 11, 12, 13, 14 are located in the housing 10, which rests on the roof 100.

Air to be conditioned is discharged from the space 102 via a through-recess 101 in the roof 100, which is provided with a grille 103. Conversely, conditioned air is introduced into the space 102 by the air conditioner 1 via the recess 101. The conditioned air is then guided via ducts in the roof 100 (not shown here).

For the conditioning of the air, the housing 10 with the components 11, 12, 13, 14 is arranged above the recess 101. The air splitter 2, which is located in the recess 101, serves to separate the two air flows (from the space 102 upwards to the cooling circuit and from the cooling circuit down into the space 102). The air splitter 2 shown below causes the room air—via the grille 103—to exit the interior 102 via the recess 101 and that the conditioned—preferably cooled—air is distributed via the ducts in the roof 100—not shown here—and thus is output via the other outlets—indicated here with the grille 103′ on the right-hand side. The air splitter 2 thus prevents in particular that the conditioned air enters the interior 102 via the recess 101 through which the air to be conditioned is discharged from the interior 102.

FIG. 2 shows an embodiment of the air splitter 2. This is essentially made up of two components: firstly, the horizontally oriented separating wall 20 and secondly, the vertically oriented distribution base 21. Both components 20, 21 form—at least when viewed from the side—the capital letter L. The separating wall 20 separates the area with the air to be conditioned (here the back area not visible) from the conditioned air. The conditioned air is distributed in two different directions via the elevation 210 in the distribution base 21. When installed, these two directions are preferably connected with ducts in the roof.

The separating wall 20 extends through the roof and therefore the height must be selected to match the thickness of the roof. This is made possible by the stair structure 200. The separating wall 20 has a thickness that decreases from bottom to top, which is realized by the stairs, which in this case have an identical stair height. In the embodiment shown, the stair structure 200 is located on the side of the distribution base 21, but can alternatively be located on the opposite rear side. The stairs allow clean edges to be created, for example by trimming the separating wall 20 to fit.

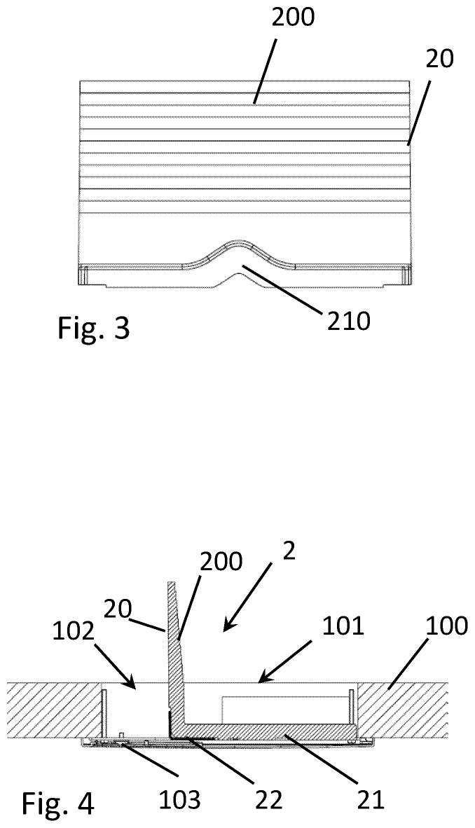

In the top view of FIG. 3, the wave-shaped elevation 210 at the bottom of the separating wall 20 can be seen again. If, for example, the cooled air hits the elevation 210 from above, it is deflected to the side—here, in the drawing, to the left and right. The illustration also shows that the stairs of the stair structure 200 run parallel to each other and to the base of the separating wall 20.

FIG. 4 shows the air splitter 2 in the installed state in the recess 102 of a roof 100. The distribution base 21 closes off a part of the recess 102 in. downwards direction. At the back of the separating wall 100 there is also a passage through which the air from the interior 102 can reach the cooling circuit of the air conditioner (not shown here). As can be seen, the separating wall 20 is significantly higher than the ceiling 100. Since the separating wall 20 is made of EPP, for example, it can be cut off along the stair structure 200 relatively easily and, above all, cleanly.

In order to prevent a thermal short circuit between the two air flows, a thermal insulation is located below the lower end of the separating wall 20 and thus the rear portion of the distribution base 21.

### LIST OF REFERENCE NUMERALS

1 air conditioner
2 air splitter
10 housing
11 compressor
12 condenser
13 expansion device
14 evaporator
20 separating wall
21 distribution base
22 insulator
100 roof
101 recess
102 interior
103 grille
103′ grille
200 stair structure
210 elevation

1-9. (canceled)

10. An air conditioner for mounting on a roof, the air conditioner comprising:
an air splitter; and
a housing,
wherein in a mounted state, the housing rests on the roof and the air splitter is at least partially arranged in a recess of the roof,
wherein the air splitter comprises a separating wall and a distribution base,
wherein the separating wall and the distribution base are designed and arranged relative to each other such that the separating wall and the distribution base form the shape of the letter L.

11. The air conditioner of claim 10, further comprising:
a plurality of components that form a refrigeration circuit,
wherein the components include at least a compressor, a condenser, an expansion device, and an evaporator, and
wherein at least one of the components is arranged in the housing.

12. The air conditioner of claim 10, wherein the separating wall of the air splitter has a stair structure.

13. The air conditioner of claim 12, wherein a thickness of the separating wall of the air splitter decreases from an area of the distribution base of the air splitter upwards.

14. The air conditioner of claim 12, wherein stairs of the stair structure have a same height.

15. The air conditioner of claim 12, wherein each stair of the stair has a top that runs essentially parallel to a base of the separating wall of the air splitter.

16. The air conditioner of claim 10, wherein the air splitter is designed in one piece.

17. The air conditioner of claim 10, wherein at least the separating wall of the air splitter comprises foamed plastic.

18. The air conditioner of claim 17, wherein the foamed plastic is expanded polypropylene.

19. The air conditioner of claim 10, wherein the distribution base of the air splitter has a wedge-shaped elevation.

20. The air conditioner of claim 10, wherein the air splitter has a thermal insulator.

21. The air conditioner of claim 20, wherein the thermal insulator is an aluminum strip.

22. The air conditioner of claim 10, wherein an angle between the separating wall and the distribution base of the air splitter deviates from a right angle by up to plus/minus 10 degrees.

23. The air conditioner of claim 10, wherein a transition between the separating wall and the distribution base of the air splitter is rounded.

24. The air conditioner of claim 10, wherein a lower part of the letter L is formed by the distribution base of the air splitter, and wherein the distribution base of the air splitter is configured to distribute conditioned air laterally in the mounted state.

25. The air conditioner of claim 10, wherein the separating wall of the air splitter separates a space behind the separating wall from a space in which the distribution base of the air splitter is located such that the distribution base is partially delimited downwards.

26. The air conditioner of claim 10, wherein in the mounted state, the separating wall of the air splitter separates a space for air to be conditioned from a space for conditioned air.

27. The air conditioner of claim 26, wherein in the mounted state, the distribution base of the air splitter is configured to distribute the conditioned air in one plane.

28. The air conditioner of claim 26, wherein in the mounted state, the distribution base of the air splitter is configured to distribute the conditioned air into a plurality of different ducts.
